(19) United States
(12) Patent Application Publication
(10) Pub. No.: US 2008/0277179 A1
(43) Pub. Date: Nov. 13, 2008

(54) Industrial Truck With A Step Recess And A Closable Maintenance Opening

(75) Inventor: Peter Elsesser, Heinrichsthal (DE)

Correspondence Address: THE WEBB LAW FIRM, P.C., 700 KOPPERS BUILDING, 436 SEVENTH AVENUE, PITTSBURGH, PA, 15219, US

(73) Assignee: Linde Material Handling GmbH, Aschaffenburg (DE)

(21) Appl. No.: 12/110,690

(22) Filed: Apr. 28, 2008

(30) Foreign Application Priority Data
May 10, 2007 (DE) 10 2007 022 279.5

(51) Int. Cl. B62D 25/24

(52) U.S. Cl. 180/89.18

(57) ABSTRACT

An industrial truck T, in particular a counterweighted fork-lift truck, has a vehicle chassis (1) which surrounds an auxiliary equipment compartment C. A step recess (5) forms a section of the boundary of the auxiliary equipment compartment. To simplify the service and maintenance of the industrial truck, the step recess (5) has a service and maintenance opening (5a) which can be closed by a service and maintenance cover (6), through which opening (5a) the auxiliary equipment compartment can be accessed.

### CROSS REFERENCE TO RELATED APPLICATION

This application claims priority to German Application Serial No. 10 2007 022 279.5, filed May 10, 2007, which is herein incorporated by reference in its entirety.

### BACKGROUND OF THE INVENTION

1. Field of the Invention

This invention relates to an industrial truck, such as a counterweighted fork-lift truck, having a vehicle chassis that surrounds an auxiliary equipment compartment and a step recess that forms the boundary of sections of the auxiliary equipment compartment.

2. Technical Considerations

Industrial trucks of the above general type are manufactured and sold by Linde Material Handling GmbH in large numbers in the form of counterweighted fork lift trucks. On these industrial trucks, the top boundary of the auxiliary equipment compartment is formed by a floor plate and a motor or battery cover. The side boundary is formed by side walls. A step recess is formed in at least one of the side walls, generally the left side wall with respect to the direction of travel to assist an operator entering and exiting the truck.

In the auxiliary equipment compartment there are, among other things, fluid reservoirs, e.g., for the hydraulic fluid of a hydraulic lifting system and/or of a hydrostatic traction drive system. The fluid level in these reservoirs must be checked at regular intervals. The fluids must also be replaced regularly. To access the fluid reservoirs and/or to access their service and maintenance openings, and depending on the position and orientation of the fluid reservoirs, the motor or battery cover or the floor plate must be removed.

Therefore, it is an object of the invention to provide an industrial truck of the general type described above but in which service and maintenance operations are simplified and/or the fluid reservoirs are easier to access.

### SUMMARY OF THE INVENTION

In one practice of the invention, the step recess has a service and maintenance opening that can be closed by a service and maintenance cover through which access to the auxiliary equipment compartment is possible.

It has been determined to be advantageous to provide at least one fluid reservoir opening for service and/or maintenance purposes in a section of the auxiliary equipment compartment that is immediately adjacent to the step recess. The fluid reservoir opening can be accessed through the service and maintenance opening by opening the service and maintenance cover.

In one advantageous embodiment of the invention, the service and maintenance opening is located in a bottom horizontal boundary surface of the step recess and the service and maintenance cover is configured such that, when the service and maintenance opening is closed by the service and maintenance cover, the cover can be used as a step or can form part of a step together with the boundary surface.

The opening of the fluid reservoir is then located in a section of the auxiliary equipment compartment that is located below the step recess.

The service and maintenance cover can advantageously be folded or pivoted so that it need not be completely removed to get to the opening of the liquid reservoir. Nevertheless, it is also possible to realize the service and maintenance cover so that it can slide or rotate or so that it can be removed.

The liquid reservoir is preferably provided in the form of an oil reservoir of a hydraulic lifting system and/or a hydraulic traction system.

### BRIEF DESCRIPTION OF THE DRAWINGS

Additional advantages and details of the invention are explained in greater detail below on the basis of the exemplary embodiment illustrated in the accompanying schematic drawings, in which:

FIG. 1 is a perspective view of an industrial truck incorporating features of the invention; and

FIG. 2 is a perspective view of a step recess of the invention.

### DESCRIPTION OF THE PREFERRED EMBODIMENTS

In the illustrated exemplary embodiment, the industrial truck T of the invention is shown in the form of a counterweighted fork-lift truck having a vehicle chassis 1, a roof frame 2 to protect the driver and a lifting platform 3 located on the front end.

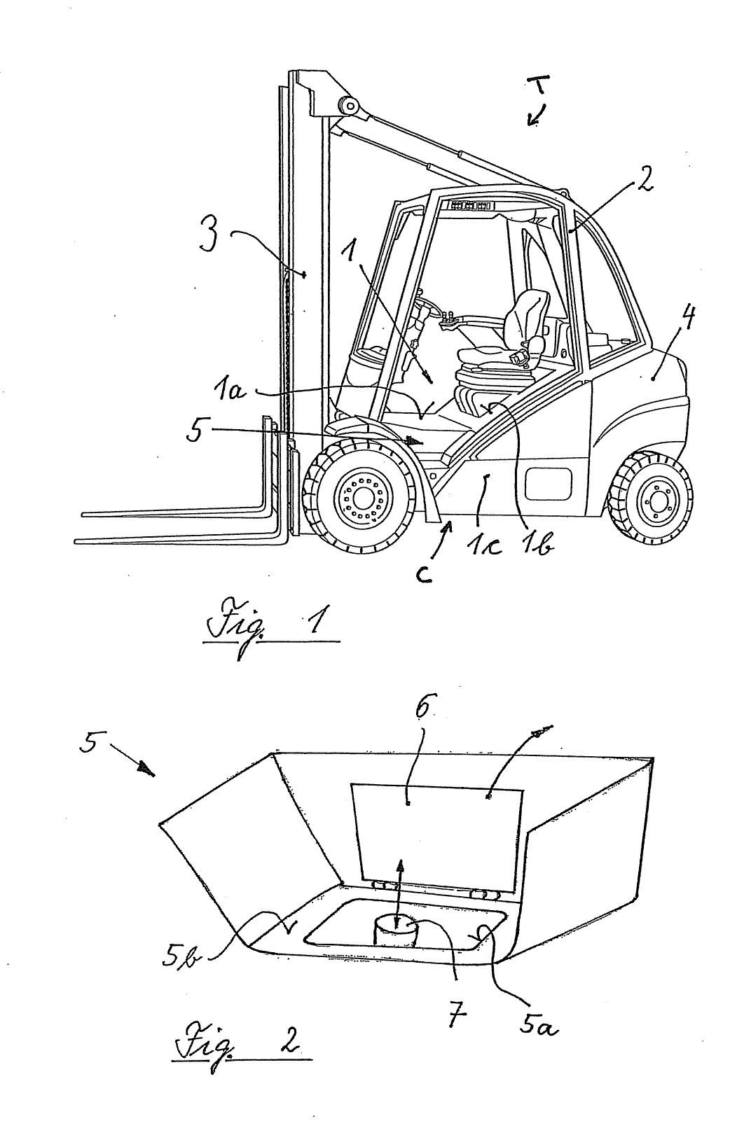

The vehicle chassis 1 encloses an auxiliary equipment compartment C and is provided with a counterweight 4 on the rear end. The auxiliary equipment compartment contains, for example, an internal combustion engine and additional drive components of a traction drive system and of a lifting drive system. The auxiliary equipment compartment can also contain one or more liquid reservoirs, such as an oil reservoir for the hydraulic fluid and for a hydraulic lifting system and/or for a hydraulic traction system. The auxiliary equipment compartment is bounded on the top by a floor plate 1a and a motor cover 1b. To the sides, the boundary is formed by side walls 1c. A step recess 5 is formed in at least one of these side walls (the left side wall 1c shown in FIG. 1) and is therefore inboard with respect to a side contour of the vehicle chassis 1.

As shown in FIG. 2, the step recess 5 is provided with a service and maintenance opening 5a which can be closed by a service and maintenance cover 6, through which opening 5a the auxiliary equipment compartment C is accessible. In the illustrated exemplary embodiment, the service and maintenance opening 5a is located in a bottom horizontal boundary surface 5b of the step recess 5. When the service and maintenance opening 5a is closed, the maintenance cover 6 serves, together with the uninterrupted area of the boundary surface 5b, as a step to facilitate an operator entering and exiting the truck.

In a section of the auxiliary equipment compartment located below the step recess 5, there is at least one opening 7 for at least one fluid reservoir, e.g., a hydraulic fluid reservoir of a hydraulic lifting system and/or a hydraulic traction system. The maintenance cover 6 can be folded or pivoted (e.g., by conventional hinges) out of the way (e.g., to an open position), so that it does not have to be removed completely to access the opening 7 of the oil reservoir through the maintenance cover 6. Alternatively, the maintenance cover 6 can be realized so that it slides or rotates, if sufficient space is available. Of course, another possible alternative is the complete removal of the maintenance cover 6.

After the maintenance cover 6 is folded up (i.e., opened), the fluid level in the oil reservoir can be checked for control purposes, e.g., by means of a dipstick. The air filter, if one is present, can also be changed and/or oil can be added, as necessary. The cover 6 can be folded down (i.e., closed) to cover the opening 5a and to act as the bottom of the step recess 5a to facilitate an operator entering or exiting the truck.

It will be readily appreciated by those skilled in the art that modifications may be made to the invention without departing from the concepts disclosed in the foregoing description. Accordingly, the particular embodiments described in detail herein are illustrative only and are not limiting to the scope of the invention, which is to be given the fall breadth of the appended claims and any and all equivalents thereof.

What is claimed is:

1. An industrial truck, comprising:
a vehicle chassis enclosing an auxiliary equipment compartment; and
a step recess formed in a section of the auxiliary equipment compartment, wherein the step recess includes a maintenance opening closable by a service and maintenance cover, and wherein the auxiliary equipment compartment is accessible through the maintenance opening.

2. The industrial truck of claim 1, wherein in a section of the auxiliary equipment compartment immediately adjacent to the step recess, there is a fluid reservoir opening provided for at least one of inspection, service or maintenance, which fluid reservoir opening is accessible through the service and maintenance opening after the service and maintenance cover is opened.

3. The industrial truck of claim 1, wherein the service and maintenance opening is located in a bottom horizontal boundary surface of the step recess such that, when the service and maintenance opening is closed, the service and maintenance cover forms at least part of a step.

4. The industrial truck of claim 2, wherein the service and maintenance opening is located in a bottom horizontal boundary surface of the step recess such that, when the service and maintenance opening is closed, the service and maintenance cover forms at least part of a step.

5. The industrial truck of claim 2, wherein the service and maintenance cover, together with the boundary surface, forms a step.

6. The industrial truck of claim 3, wherein the service and maintenance cover, together with the boundary surface, forms a step.

7. The industrial truck of claim 1, wherein the service and maintenance cover can be folded or pivoted.

8. The industrial truck of claim 2, wherein the service and maintenance cover can be folded or pivoted.

9. The industrial truck of claim 3, wherein the service and maintenance cover can be folded or pivoted.

10. The industrial truck of claim 2, wherein the fluid container is selected from at least one of an oil reservoir of a hydraulic lifting system and an oil reservoir of a hydraulic traction system.

11. The industrial truck of claim 3, wherein the fluid container is selected from at least one of an oil reservoir of a hydraulic lifting system and an oil reservoir of a hydraulic traction system.

12. The industrial truck of claim 4, wherein the fluid container is selected from at least one of an oil reservoir of a hydraulic lifting system and an oil reservoir of a hydraulic traction system.
